(19) United States
(12) Patent Application Publication
(10) Pub. No.: US 2010/0217923 A1
(43) Pub. Date: Aug. 26, 2010

(54) STORAGE DEVICE WITH FLASH MEMORY

(75) Inventor: Yosuke MITSUMASU, Hadano-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/712,013

(22) Filed: Feb. 24, 2010

(30) Foreign Application Priority Data
Feb. 24, 2009 (JP) 2009-040167

(51) Int. Cl. G06F 12/00; G06F 12/02; G06F 12/06

(52) U.S. Cl. 711/103; 711/171; 711/E12.001; 711/E12.008; 711/E12.078

(57) ABSTRACT

According to one embodiment, a write detector detects a predetermined state where a flash memory contains an area to which write data subject to a write request from a host is to be written and from which data has been erased. A data reception controller allows a data buffer to receive the requested write data in accordance with the detection of the predetermined state.

### CROSS-REFERENCE TO RELATED APPLICATIONS

This application is based upon and claims the benefit of priority from Japanese Patent Application No. 2009-040167, filed Feb. 24, 2009, the entire contents of which are incorporated herein by reference.

### BACKGROUND

1. Field

One embodiment of the invention relates to, for example, a storage device, a method for controlling the storage device, and an electronic device comprising the storage device, and in particular, to a storage device with a flash memory, a method for controlling the storage device, and an electronic device comprising the storage device.

2. Description of the Related Art

As storage devices for electronic devices such as personal computers, magnetic disk drives (HDDs) are mainly used. HDD includes driving components such as a head and a motor. Thus, HDD offers insufficient impact resistance. Physical impact may cause HDD to malfunction or go out of order. Furthermore, HDD involves a seek time required to move the head and a spin-up time required to increase the rotation number of a disk. This may result in a loss of time. Hence, in recent years, a storage device called a solid state drive (SSD) has been developed as an alternative to HDDs; in the solid state drive (SSD), flash memory, which is a nonvolatile memory, is used to store data.

When data is written to a flash memory, data already written to an area to which the above-described data is to be written needs to be pre-erased in units of blocks. Such erasure of data in units of blocks requires a much longer time than data reading or data writing. Furthermore, the flash memory is characterized in that the number of times that data in the flash memory can be rewritten is finite (normally 10⁵ to 10⁶ times).

Thus, for example, Jpn. Pat. Appln. KOKAI Publication No. 2002-304320 discloses a first method in which when data is written to a flash memory, the data writing can be immediately performed without the need to erase the existing data before the data writing. According to the first method, after the data writing, data in a certain area in a flag memory is pre-erased in preparation for the next data writing. This provides the area in which no data is written.

The following second method of using a data buffer is applied to a storage device with a flash memory in order to reduce the number of times that data is written to the memory. A nonvolatile memory such as dynamic random access memory (DRAM) is used as the data buffer. According to the second method, the data writing is performed in the data buffer. In the second method, after the data buffer becomes full of data, the data in the data buffer is written to the flash memory.

However, in the second method, if the storage device is powered off, the data stored in the data buffer is lost before being written to the flash memory. Thus, the storage device to which the second method is applied uses a secondary cell such as a battery or a capacitor, as a backup power source. Hence, even if the storage device is powered off, a sufficient time to write the data stored in the data buffer to the flash memory is available.

The data writing to the flash memory generally requires performance of a data erase before the data writing as described. This requires a very long time. Therefore, the storage device to which the second method is applied requires a high-capacity secondary cell.

On the other hand, the first method does not necessarily reliably provide an area in which no data is stored and which is actually required in order to allow data to be written to the area. Thus, even with the application of the first method, when data writing is performed, a data erase may need to be carried our before the data writing.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram illustrating the exemplary configuration of a storage device according to an embodiment of the invention;

FIG. 2 is a diagram illustrating an example of the data structure of a data buffer management table applied in the embodiment;

FIG. 3 is a flowchart illustrating a write data reception process applied in the prior art;

FIGS. 4A and 4B are diagrams respectively illustrating first data storage states of a data buffer and a flash memory in the write data reception process applied in the prior art;

FIGS. 5A and 5B are diagrams respectively illustrating second data storage states of the data buffer and flash memory in the write data reception process applied in the prior art;

FIGS. 6A and 6B are diagrams illustrating an example in which a data erase is required before data writing in the prior art;

FIG. 7 is a block diagram showing the exemplary functional configuration of an MPU in a storage device applied in the embodiment;

FIG. 8 is a flowchart illustrating an exemplary write data reception process applied in the embodiment;

FIGS. 9A and 9B are diagrams respectively illustrating examples of first data storage states of a data buffer and a flash memory in the write data reception process applied in the embodiment;

FIGS. 10A and 10B are diagrams respectively illustrating examples of second data storage states of the data buffer and flash memory in the write data reception process applied in the embodiment;

FIG. 11 is a block diagram showing the exemplary functional configuration of an MPU in a storage device applied in a modification of the embodiment;

FIG. 12 is a flowchart illustrating an exemplary write data reception process applied in the modification of the embodiment;

FIGS. 13A and 13B are diagrams respectively illustrating examples of first data storage states of a data buffer and a flash memory in the write data reception process applied in the modification of the embodiment;

FIGS. 14A and 14B are diagrams respectively illustrating examples of second data storage states of the data buffer and flash memory in the write data reception process applied in the modification of the embodiment;

FIGS. 15A and 15B are diagrams respectively illustrating examples of third data storage states of the data buffer and flash memory in the write data reception process applied in the modification of the embodiment;

FIGS. 16A and 16B are diagrams respectively illustrating examples of fourth data storage states of the data buffer and flash memory in the write data reception process applied in the modification of the embodiment;

FIG. 17 is a diagram illustrating an example of the data structure of a data buffer management table applied in the modification of the embodiment; and

FIG. 18 is a block diagram illustrating the configuration of an electronic device comprising the storage device shown in FIG. 1.

### DETAILED DESCRIPTION

Various embodiments according to the invention will be described hereinafter with reference to the accompanying drawings. In general, according to one embodiment of the invention, there is provided a storage device. The storage device comprises: a flash memory; a write detector configured to detect a predetermined state where the flash memory contains an area to which write data subject to a write request from a host is to be written and from which data has been erased; and a data reception controller configured to allow a data buffer to receive the requested write data in accordance with the detection of the predetermined state.

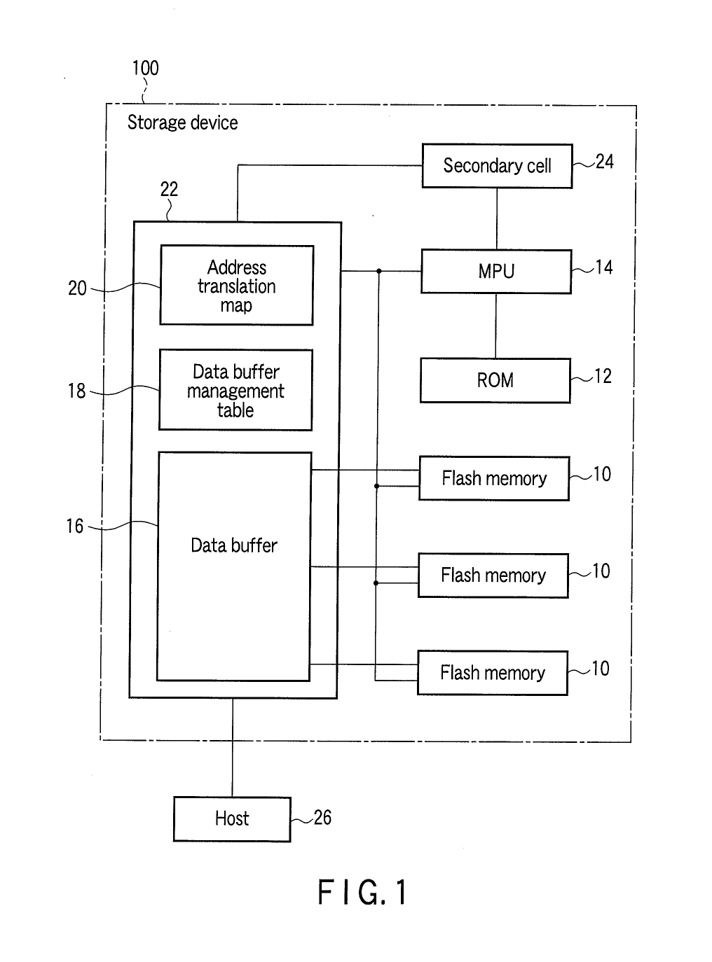

FIG. 1 is a block diagram showing the configuration of a storage device according to an embodiment of the invention. In FIG. 1, a storage device 100 is, for example, a flash solid-state drive (flash SSD). The storage device 100 comprises three flash memories 10, a read-only memory (ROM) 12, a microprocessing unit (MPU) 14, a random access memory (RAM) 22, and a secondary cell 24. A part of the storage area in the RAM 22 is used for a data buffer 16. Another part of the storage area in the RAM 22 is used to store a data buffer management table 18. Another part of the storage area in the RAM 22 is used as an area for an address translation map 20.

The flash memory 10 is used as a data storage element configured to store write data from a host 26. The storage area in the flash memory 10 is divided into a plurality of pages. The page is a unit based on which data can be written and read. Furthermore, in the flash memory 10, data can be erased in units of blocks each comprising a plurality of pages. Additionally, in the storage device 100 shown in FIG. 1, three flash memories 10 are connected together in parallel and to the RAM 22. Thus, the three flash memories 10 can simultaneously perform a read/write (parallel processing). This serves to increase the transfer rate of the storage device 100.

The ROM 12 is configured to pre-store a control program executed by the MPU 14. The MPU 14 controls the storage device 100 as a whole; the MPU 14 performs, for example, control for receiving write data transmitted by the host 26 and control for writing write data to the flash memory 10. The data buffer 16 is configured to temporarily store write data transmitted by the host 26 and data read from the flash memory 10. The storage area in the data buffer 16 is divided into a plurality of buffer areas Bi (i=1, 2, . . , n) for management. In the embodiment, “n” is 8 as described below. However, “n” is not limited to 8.

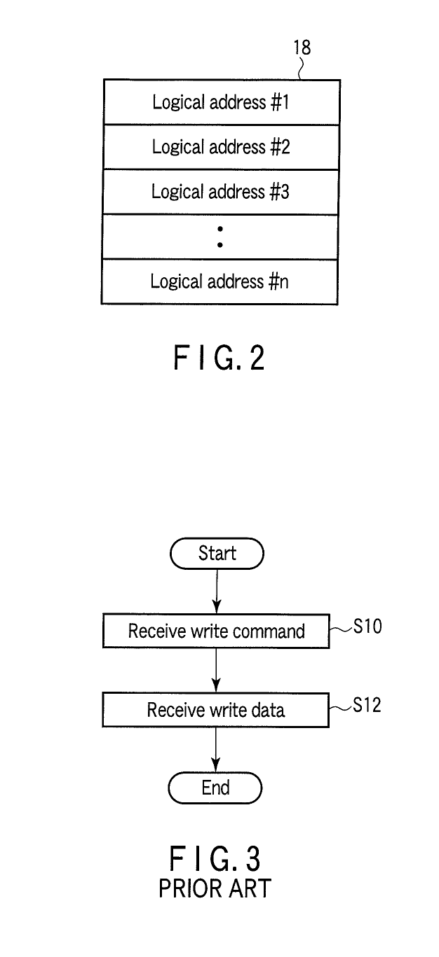

The data buffer management table 18 is used to manage a logical address in each of the buffer areas in the data buffer 16. FIG. 2 shows an example of the data structure of the data buffer management table 18. As is the case with the prior art, the data buffer management table 18 holds, in each of the buffer areas Bi in the data buffer 16, a logical address #i corresponding to data stored in the buffer area Bi. The logical address #i corresponding to the data stored in the buffer area Bi represents the logical address indicative of the write destination of the data. With reference to the data buffer management table 18 with the data structure shown in FIG. 2, one of the data items stored in the data buffer 16 can be accessed which corresponds to the logical address input by the host 26.

The address translation map 20 is configured to store an address translation table in which logical addresses input by the host 26 is associated with a corresponding physical address in the flash memory 10. With reference to the address translation table, the MPU 14 can access the physical address in the flash memory 10 which corresponds to the logical address input by the host 26. The information in the address translation table is transferred to and stored in at least one of the flash memories 10 when the storage device 100 is powered off. Then, when the storage device 100 is powered on, the information from the address translation table stored in the flash memory 10 is transferred again to the address translation map 20.

The secondary cell 24 is, for example, a battery or a capacitor, and is used as a backup power source for power supply to the storage device 100. More specifically, the secondary cell 24 is used to provide time required to write the data stored in the data buffer 16 to the flash memory 10 when the storage device 100 is powered off.

For comparison with the embodiment, a write data reception process in the prior art will be described below with reference to FIGS. 3, 4A, 4B, 5A, and 5B. For convenience of explanation, the write data reception process in the prior art is assumed to be executed by the storage device 100 shown in FIG. 1. The write data reception process is executed in order to receive and store write data from the host 26 into the data buffer 16 when the data writing is requested from the host 26.

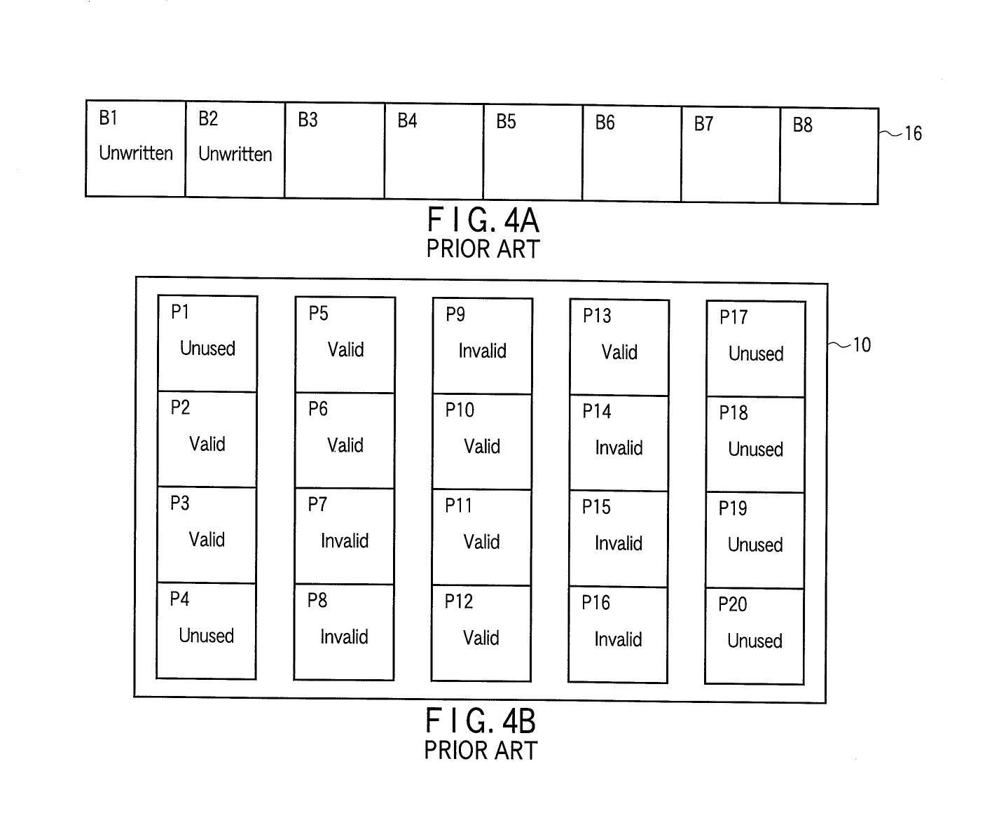

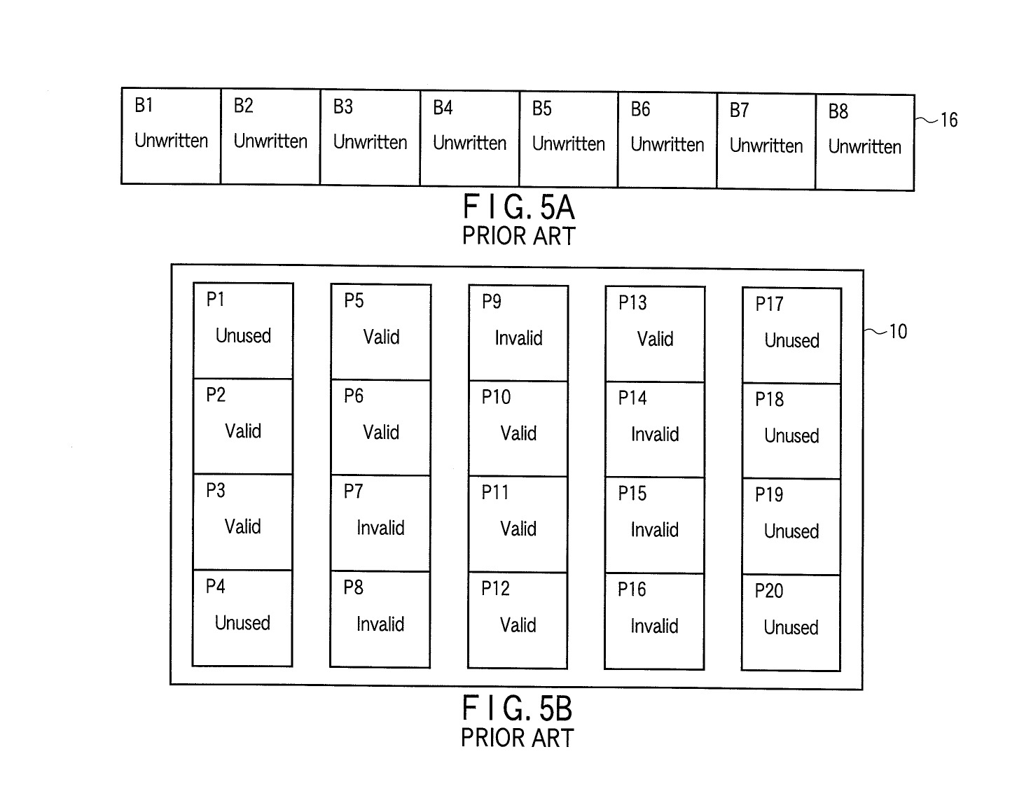

FIG. 3 is a flowchart illustrating the write data reception process in the prior art. FIGS. 4A and 4B are diagrams respectively illustrating first data storage states of the data buffer 16 and the flash memory 10 in the write data reception process. FIGS. 5A and 5B are diagrams respectively illustrating second data storage states of the data buffer 16 and the flash memory 10 in the write data reception process.

First, with reference to FIGS. 4A and 4B, the first data storage states of the data buffer 16 and the flash memory 10 prior to reception of a write command from the host 26 will be described. P1 to P20 in the flash memory 10 denote first blocks into which the storage area in the flash memory 10 is divided. Data in the flash memory 10 is erased in units of first blocks. B1 to B8 in the data buffer 16 denote second blocks corresponding to the buffer areas into which the storage area in the data buffer 16 is divided. Each of B1 to B8 has the same size as the first blocks. In the description below, the first block Pj (j=1, 2, . . . , 20) is simply denoted by Pj. The second block Bi (i=1, 2, . . . , 8) is simply denoted by Bi.

The data storage state of Pj in the flash memory 10 is one of a valid state, an invalid state, or an unused state. The valid Pj means that data actually used (that is, valid data) is stored in Pj. The invalid Pj means that data is stored in Pj but is not actually used and is thus invalid. The unused Pj means that the data in Pj has been erased and thus stores no data.

On the other hand, in the data buffer 10, B1 and B2 are in an unwritten data storage state. That is, data received from the host 26 is stored in B1 and B2. However, the data stored in B1 and B2 has not been written to the flash memory 10 yet. No data is stored in B3 and B8.

In the states shown in FIGS. 4A and 4B, upon receiving a write command from the host 26 (block S10), the MPU 14 allows the data buffer 16 to receive write data corresponding to the write command (block S12).

FIGS. 5A and 5B respectively show examples of the data storage states of the data buffer 16 and the flash memory 10 observed when in the states shown in FIGS. 4A and 4B, the data buffer 16 receives, for example, six blocks of write data.

In this case, as shown in FIG. 5A, the six blocks of write data newly received from the host 26 are stored in B3 to B8. In this manner, the write data reception process is executed so as to allow the data buffer 16 to receive the write data from the host 26. In this state, the data stored in B1 to B8 has not written to the flash memory 10 yet.

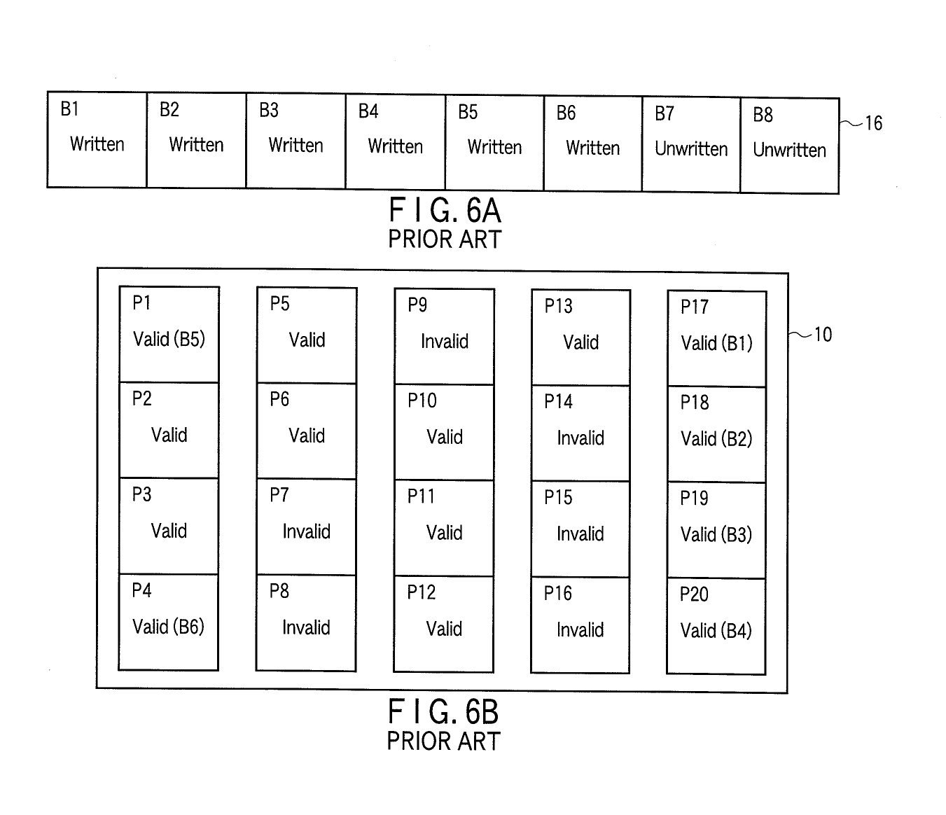

Now, it is assumed that in the states shown in FIGS. 5A and 5B, the storage device 100 is powered off. In this case, instead of the power source for the storage device 100, the secondary cell 24, serving as a backup power source, applies (supplies) a voltage (power) to the MPU 14, RAM 22, and the like in the storage device 100. Thus, the data stored in the data buffer 16 is written to the flash memory 10 under the control of the MPU 14. Here, six blocks (P1, P4, and P17 to P20) of P1 to P20 in the flash memory 10 are unused; the data in these blocks has been erased. In the states shown in FIGS. 5A and 5B, the data stored in, for example, B1, B2, B3, B4, B5, and B6 in the data buffer 16 can be written, for example, as shown in FIGS. 6, to P17, P18, P19, P20, P1 and P4, respectively, without the need for a data erase operation. However, to allow the data stored in B7 and B8 to be written to the flash memory 10, the data stored in two invalid data blocks (for example, P7 and P8) in the flash memory 10 needs to be erased. After this data erase, the data stored in B7 and B8 can be written to P7 and P8.

As described in Description of the Related Art, the erasure of data in units of blocks requires a very long time. That is, writing the data in B7 and B8 to P7 and P8, respectively, requires a very long time. If the secondary cell 24 has a small capacity, the time required for a series of operation including data erasing and data writing cannot be provided. In this case, the power supply from the secondary cell 24 may be interrupted before the data in P7 and B8 is written to P7 and P8. As a result, the data may be lost.

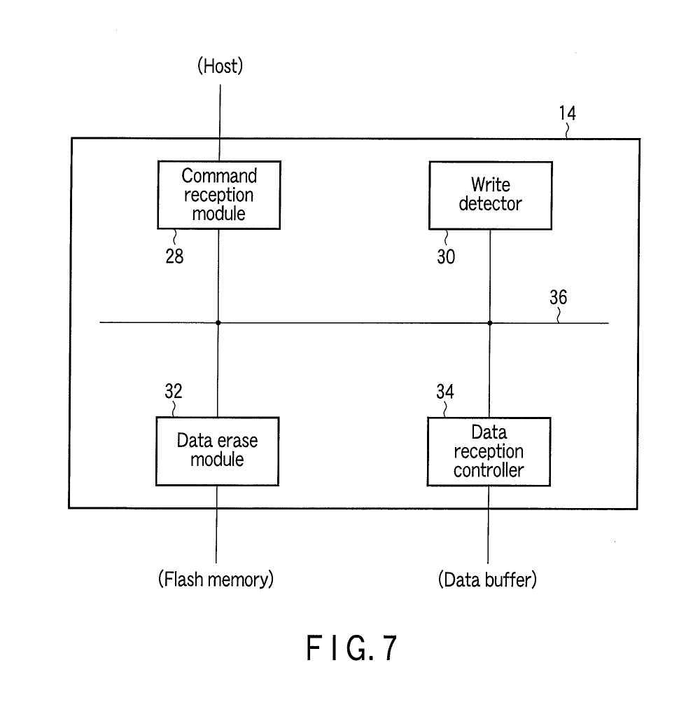

Thus, the embodiment uses a configuration designed to write all the data in the data buffer 16 to the flash memory 10 in a short time. This configuration will be described below. FIG. 7 is a block diagram showing the functional configuration of the MPU 14 in the storage device 100 applied in the embodiment. The MPU 14 comprises a command reception module 28, a write detector 30, a data erase module 32, and a data reception controller 34. The command reception module 28, the write detector 30, the data erase module 32, and the data reception controller 34 are connected together by a system bus 36. Furthermore, the command reception module 28, the write detector 30, the data erase module 32, and the data reception controller 34 are allowed to function by the MPU 14 by executing the control program stored in the ROM 12.

The command reception module 28 receives write commands and the like input by the host 26. The write detector 30 detects (determines) whether or not all of the write data corresponding to the write command received by the command reception module 28 can be written to the flash memory 10 without the need for a data erase operation intended for the first block in the flash memory 10. A specific detection method of detecting whether or not all of the write data can be written to the flash memory 10 will be described later. In the description below, the data erase operation intended for the first block in the flash memory 10 is simply referred to as a data erase operation.

If the write detector 30 detects that not all of the write data can be written to the flash memory 10, the data erase module 32 selects those first blocks in the flash memory 10 that hold invalid data and erases the invalid data from these first blocks. If the write detector 30 detects that all of the write data can be written to the flash memory, the data reception controller 34 allows the data buffer 16 to receive, from the host 26, all of the write data corresponding to the write command received by the command reception module 28.

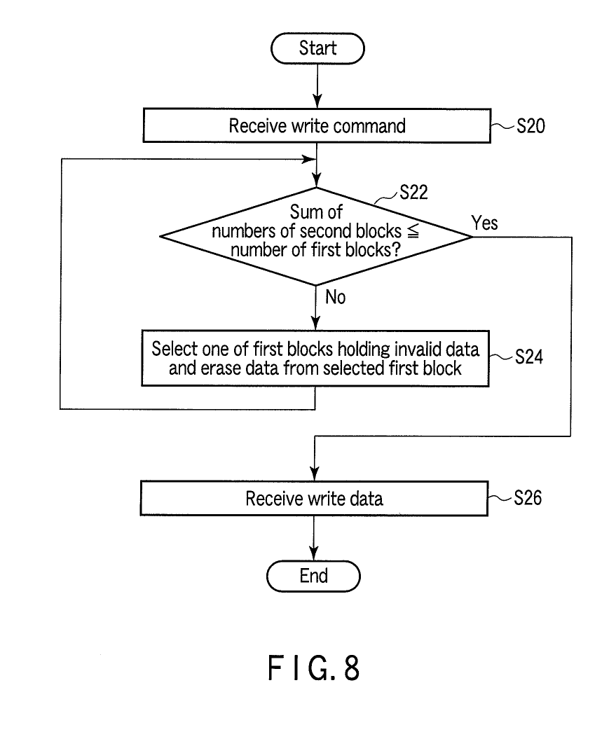

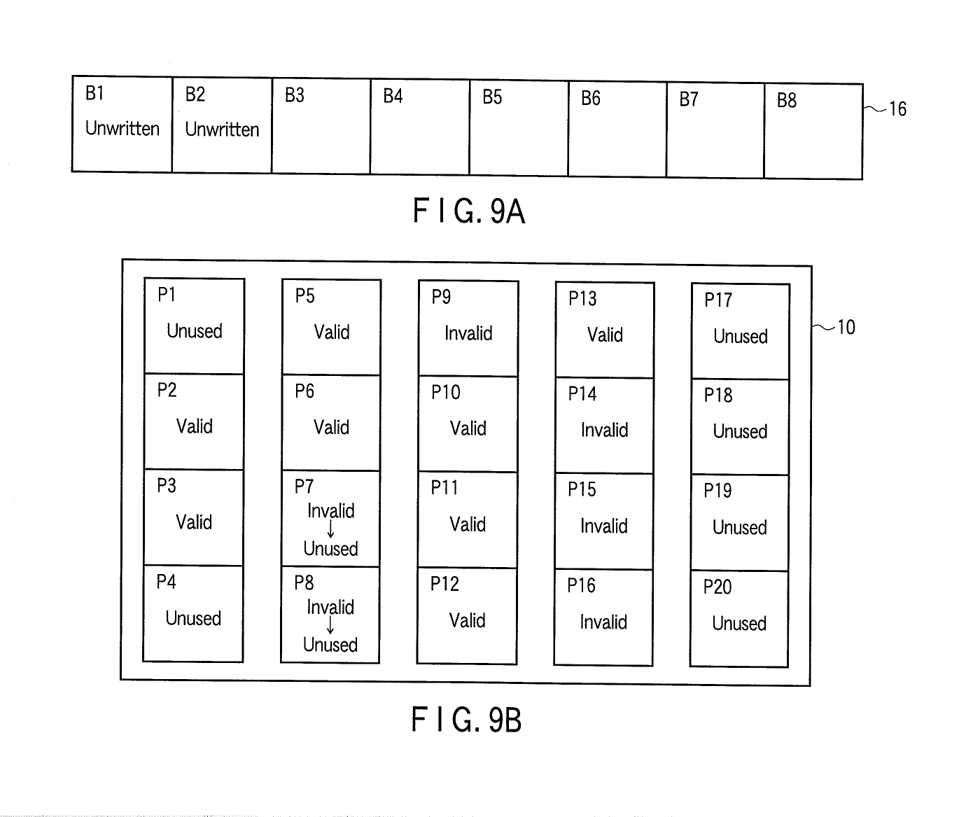

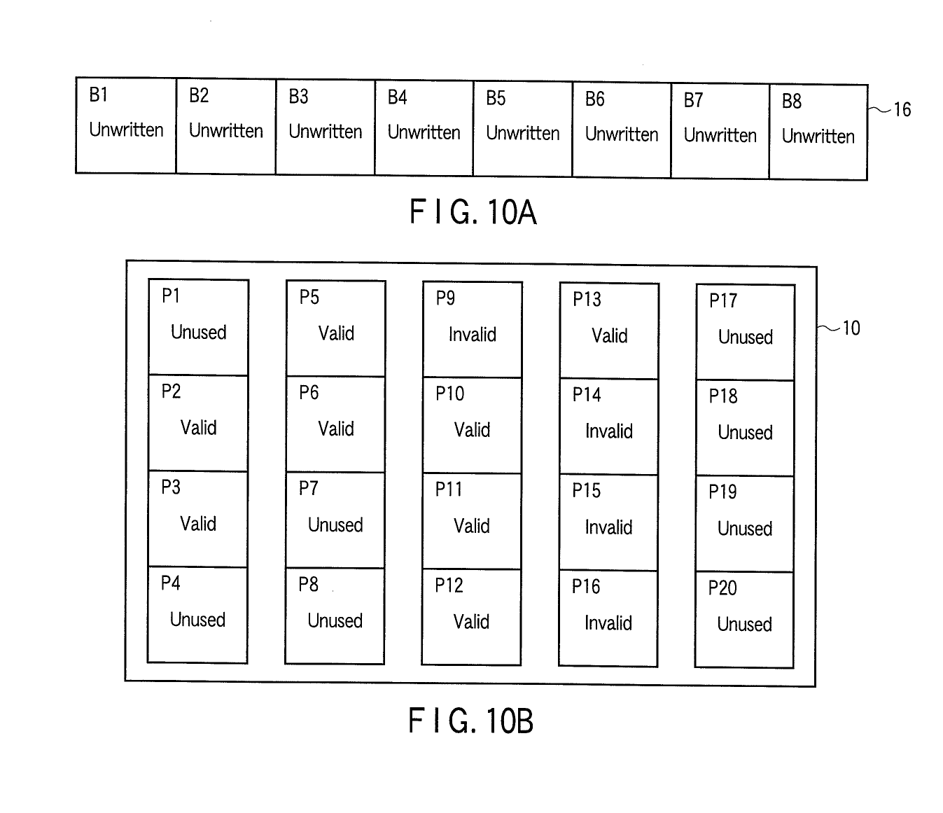

Now, with reference to FIGS. 8, 9A, 9B, 10A, and 10B, description will be given of a write data reception process applied in the embodiment in order to allow the data buffer 16 to receive write data from the host 26 if the host 26 has requested the data writing. FIG. 8 is a flowchart illustrating the write data reception process applied in the embodiment. FIGS. 9A and 9B are diagrams respectively illustrating first data storage states of the data buffer 16 and the flash memory 10 observed when the write data reception process applied in the embodiment is started. FIGS. 10A and 10B are diagrams respectively illustrating second data storage states of the data buffer 16 and the flash memory 10 during the write data reception process applied in the embodiment.

First, it is assumed that before the MPU 14 receives a write command from the host 26, the data storage states of the data buffer 16 and the flash memory 10 are the same as those shown in FIGS. 4A and 4B. It is further assumed that in this state, the MPU 14 receives the write command from the host 26 (block 20).

Then, the MPU 14 calculates the sum (Na+Nb) of the number of second blocks Na and the number of second blocks Nb. Na denotes the number of second blocks occupied by the data already stored in the data buffer 16. Nb denotes the number of second blocks occupied by the write data corresponding to the write command received from the host 26 given that all the write data is to be stored in the data buffer 16. That is, Nb denotes the number of second blocks to be occupied by the write data corresponding to the write command. Here, as a specific example, it is assumed that the write command received by the MPU 14 requests writing of six blocks of data (Nb=6). In this case, as shown in FIG. 4A, data has already stored in B1 and B2 in the data buffer 16 (Na=2). The MPU 14 calculates the sum (Na+Nb) of the numbers of second blocks to be 8.

Then, the MPU 14 calculates the number of those first blocks in the flash memory 10 from which data has been erased. In FIG. 4B, the first blocks from which data has been erased are P1, P4, and P17 to P20. The MPU 14 thus calculates the number of first blocks from which data has been erased to be six.

Then, the MPU 14 detects whether or not the calculated sum of the numbers of second blocks is less than or equal to the calculated number of first blocks from which data has been erased (block S22). If the calculated sum of the numbers of second blocks is less than or equal to the calculated number of first blocks from which data has been erased, the MPU 14 detects (determines) that all of the write data from the host 26 can be written to the flash memory 10 without the need for a data erase operation. That is, the MPU 14 detects a predetermined state in which an area from which data has been erased and to which all of the write data from the host 26 is to be written is present in the flash memory 10.

In the embodiment, the calculated sum of the numbers of second blocks is eight. The number of first blocks from which data has been erased is six. Thus, the MPU 14 determines that the number of first blocks from which data has been erased is smaller. In this case, the MPU 14 determines that a data erase operation is required to enable the write data corresponding to the received write command to be written to the flash memory 10, that is, to provide an area from which data has been erased and to which all of the write data from the host 26 is to be written.

Upon determining that the number of first blocks is smaller (No in block S22), the MPU 14 selects one of at least one first block in the flash memory 10 that hold invalid data, and then erases the invalid data from the selected first block (block S24). For example, the MPU 14 selects P7 that holds invalid data from the flash memory 10 in the state shown in FIG. 4, and then erases the data from P7. Thus, P7 shifts from the invalid state to the unused state where the data in P7 has been erased.

Upon executing block S24, the MPU 14 determines again whether or not the calculated sum of the numbers of second blocks is less than or equal to the number of first blocks from which data has been erased (block S22). In this case, since the data in P7 has been erased, the number of first blocks from which data has been erased has increased from six in the state shown in FIG. 4B to seven. However, the MPU 14 determines again that the number of first blocks from which data has been erased is smaller.

The process proceeds to block S24 again. The MPU 24 selects one of at least one first block in the flash memory 10 that holds invalid data, and then erases the invalid data from the selected first block. For example, the MPU 14 selects P8, and then erases data from P8. Thus, the data storage states of the data buffer 16 and the flash memory 10 are as shown in FIGS. 9A and 9B, respectively.

The MPU 14 determines again whether or not the calculated sum of the numbers of second blocks is less than or equal to the number of first blocks from which data has been erased (block S22). In the state shown in FIG. 9B, the number of first blocks from which data has been erased is eight. Thus, the MPU 14 determines that the calculated sum of the numbers of second blocks is less than or equal to the number of first blocks from which data has been erased. In this case, the MPU 14 determines that all of the write data from the host 26 can be written to the flash memory 10 without the need for a data erase operation.

Upon determining that the calculated sum of the numbers of second blocks is less than or equal to the number of first blocks from which data has been erased (Yes in block S22), the MPU 14 allows the data buffer 16 to receive the write data corresponding to the write command received from the host 26 (block S26). Thus, as shown in FIG. 10A, six blocks of write data are received and stored in B3 to B8 in the data buffer 16.

In the above description, the process in accordance with the flowchart in FIG. 8 is executed by the MPU 14. More specifically, block S20 is executed by the command reception module 28 in the MPU 14. Block S22 is executed by the write detector 30 in the MPU 14. Block S24 is executed by the data erase module 32 in the MPU 14. Block S26 is executed by the data reception controller 34 in the MPU 14.

Here, it is assumed that in the states shown in FIGS. 10A and 10B, the storage device 100 is powered off. In this case, instead of the power source for the storage device 100, the secondary cell 24, serving as a backup power source, applies (supplies) a voltage (power) to the MPU 14, RAM 22, and the like in the storage device 100. Thus, the data stored in the data buffer 16 is written to the flash memory 10 under the control of the MPU 14. Here, eight blocks (P1, P4, P7, P8, and P17 to P20) of P1 to P20 in the flash memory 10 are unused; the data in these blocks has been erased. Hence, in the states shown in FIGS. 10A and 10B, the data stored in B1, B2, B3, B4, B5, B6, B7, and B8 in the data buffer 16 can be written to, for example, P17, P18, P19, P20, P1, P4, P7, and P8, respectively, without the need for a data erase operation intended for the flash memory 10.

As described above, according to the embodiment, if the sum of the number of second blocks occupied by the data already stored in the data buffer 16 and the number of second blocks to be occupied by write data to be newly transmitted by the host 26 is less than or equal to the number of first blocks from which data has been erased, that is, if the above-described predetermined state is detected, the MPU 14 allows the data buffer 16 to receive the new write data. Thus, the data stored in the data buffer 16 can be written to the flash memory 10 without the need for a data erase operation. That is, according to the embodiment, all the data stored in the data buffer 16 can be written to the flash memory 10 in a short time. Hence, even if the capacity of the secondary cell 24 is reduced, all the data stored in the data buffer 16 can be written to the flash memory 10 while power is being supplied by the secondary cell 24. In other words, the capacity of the secondary cell 24 can be reduced without causing a loss of the data stored in the data buffer 16.

Furthermore, the embodiment avoids performing a data erase operation while power is being supplied by the secondary cell 24. That is, the embodiment avoids performing a data erase operation, which requires a high voltage, while power is being supplied by the secondary cell 24. This allows a reduction in the voltage of the secondary cell 24.

### Modification

Now, a modification of the embodiment will be described. The modification differs from the embodiment in the control program pre-stored in the ROM 12 in the storage device 100. Thus, the modification also differs from the embodiment (see FIG. 7) in the functional configuration of the MPU 14 in the storage device 100.

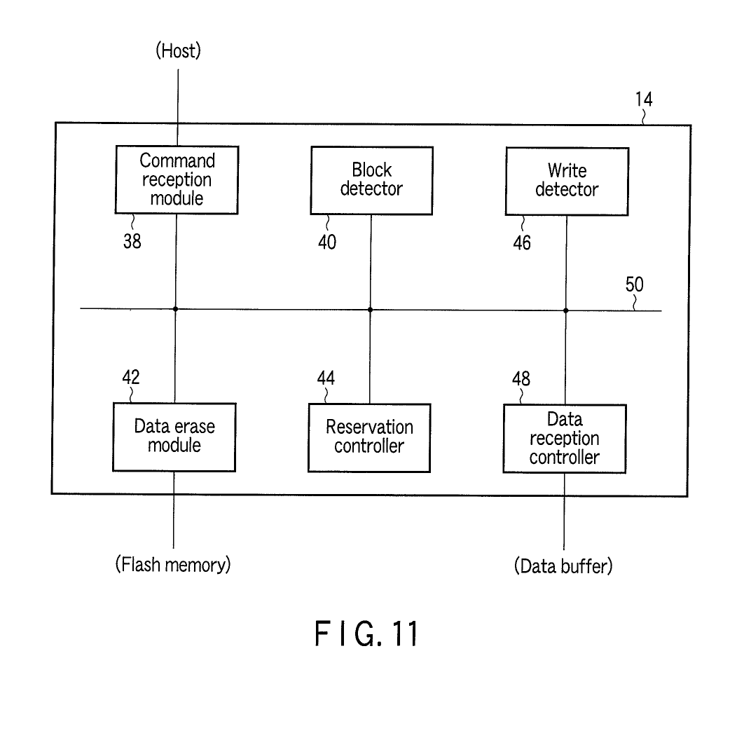

FIG. 11 is a block diagram showing the functional configuration of the MPU 14 in the storage device 100 applied in the modification. In the modification, the MPU 14 comprises a command reception module 38, a block detector 40, a data erase module 42, a reservation controller 44, a write detector 46, and a data reception controller 48. The command reception module 38, the block detector 40, the data erase module 42, the reservation controller 44, the write detector 46, and the data reception controller 48 are connected together by a system bus 50. Furthermore, the command reception module 38, the block detector 40, the data erase module 42, the reservation controller 44, the write detector 46, and the data reception controller 48 are allowed to function by the MPU 14 by executing the control program stored in the ROM 12.

The command reception module 38 receives write commands and the like input by the host 26. If the command reception module 38 receives a write command, the block detector 40 detects whether or not data has been erased from any of the first blocks in the flash memory 10. If the block detector 40 detects that data has not been erased from any of the first blocks, the data erase module 42 selects those first blocks that hold invalid data, and erases the invalid data from these first blocks.

The reservation controller 44 functions if the block detector 40 detects that data has been erased from any of the first blocks or if the data in any first block is erased by the data erase module 42. The reservation controller 44 reserves data writing to a first block from which data has been erased, using a second block in which the write data corresponding to the write command received by the command reception module 38 is to be stored.

The write detector 46 detects whether or not the write data corresponding to the write command received by the command reception module 38 can be written to the flash memory 10 without the need for a data erase operation. A specific detection method of detecting whether or not the write data can be written to the flash memory 10 will be described below. If the write detector 46 detects that the write data can be written to the flash memory 10, the data reception controller 48 allows the data buffer 16 to receive, from the host 26, all of the write data corresponding to the write command received by the command reception module 38.

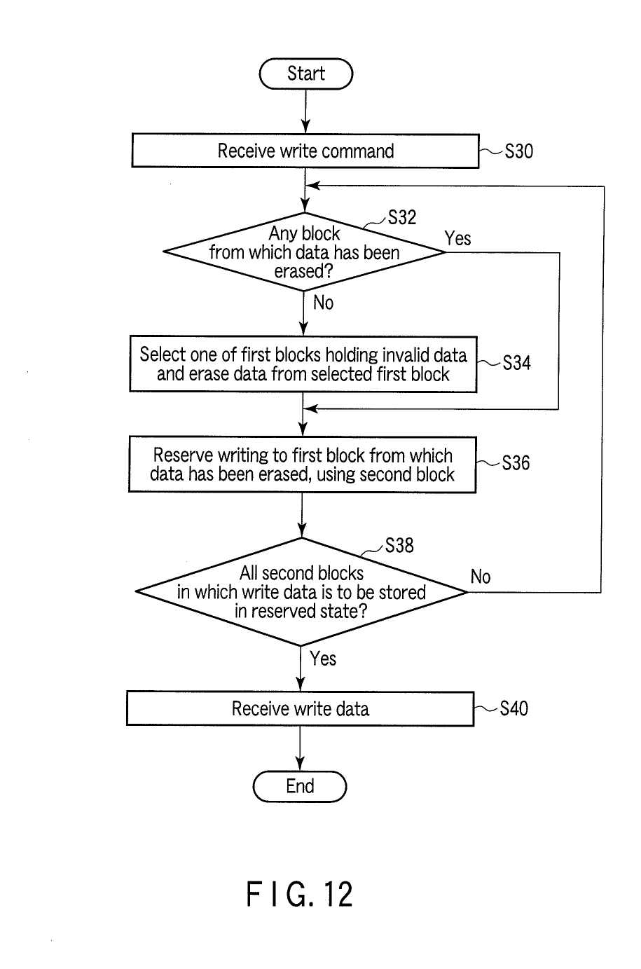

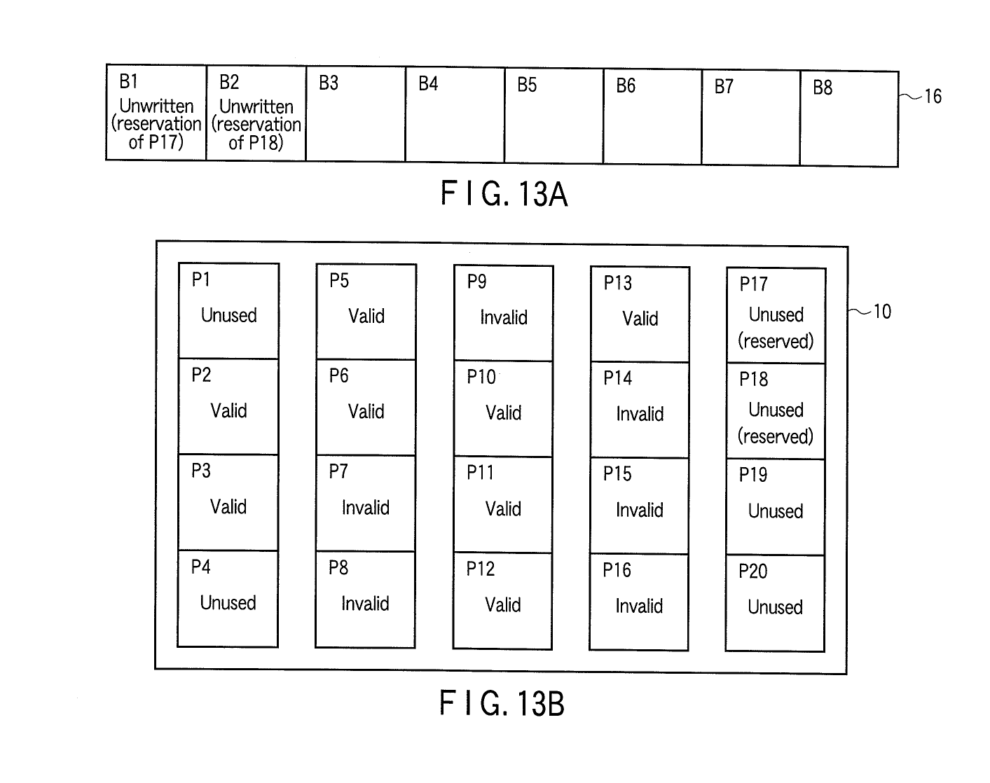

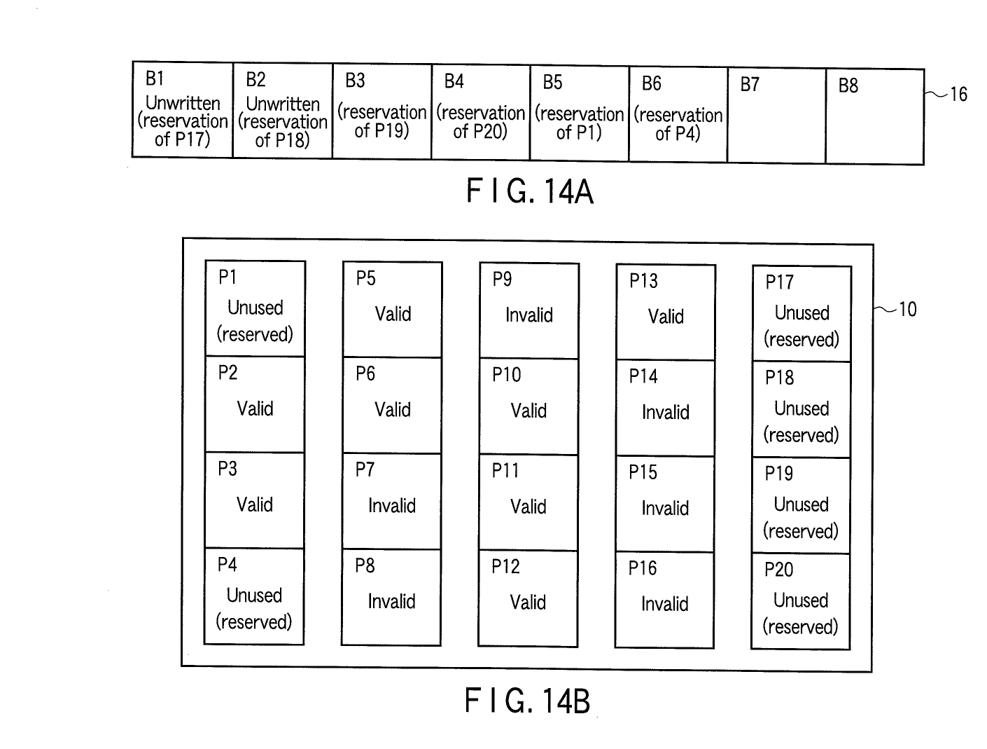

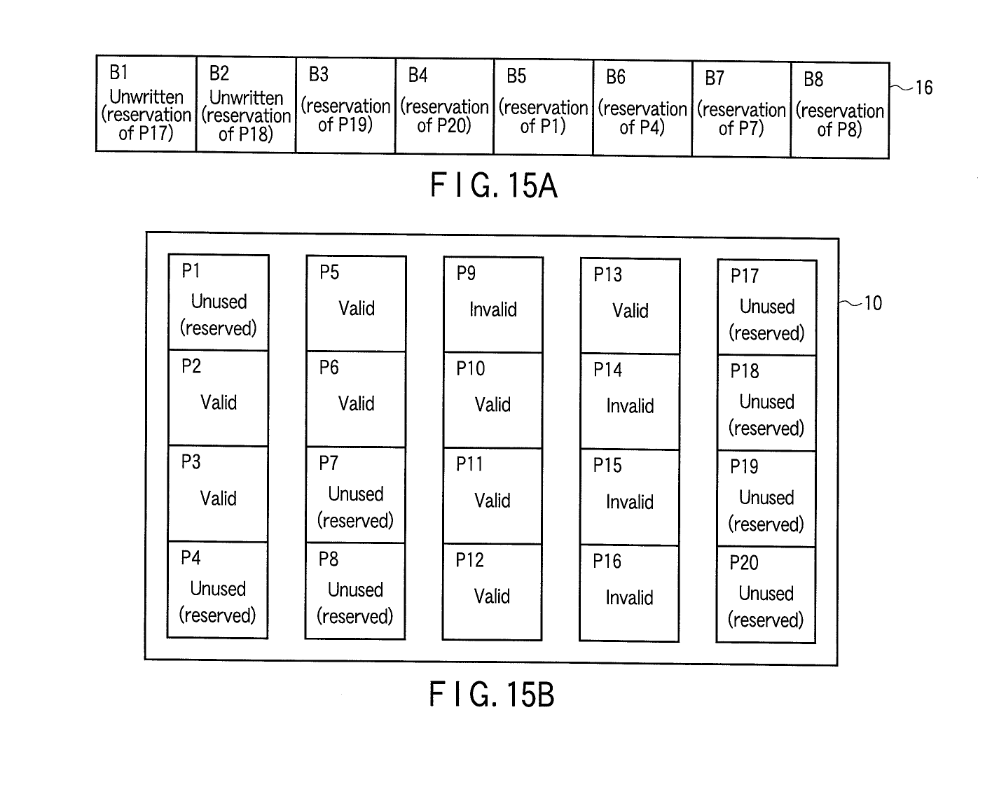

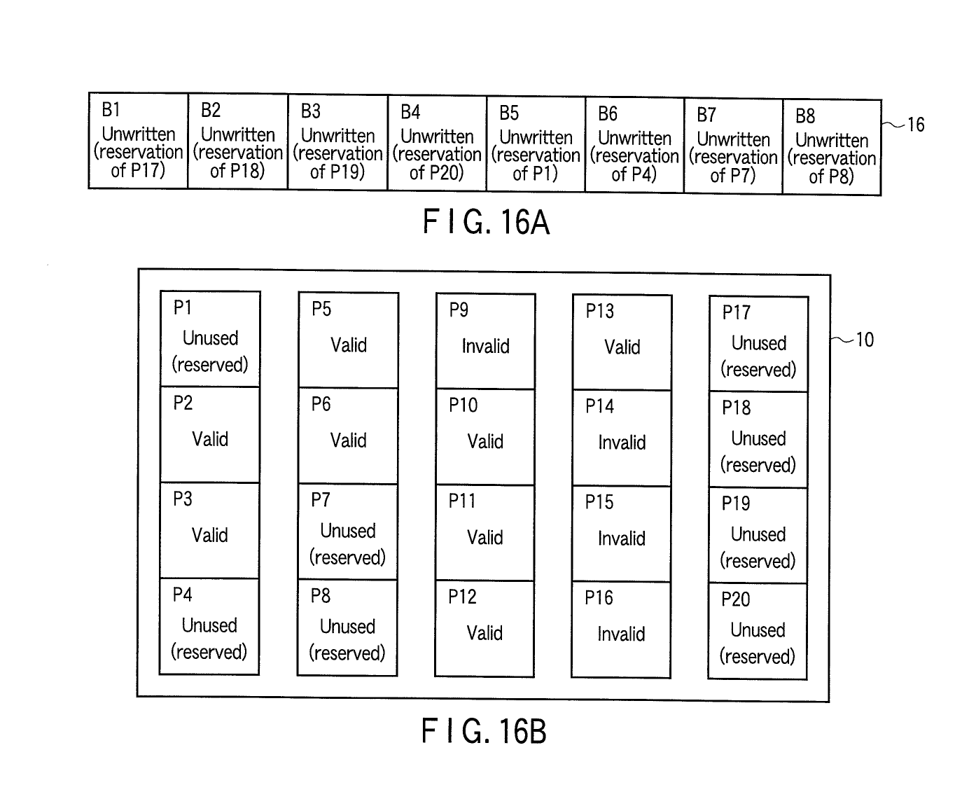

Now, with reference to FIGS. 12, 13A, 13B, 14A, 14B, 15A, 15B, 16A, and 16B, description will be given of a write data reception process applied in the modification of the embodiment in order to allow the data buffer 16 to receive write data from the host 26 if the host 26 has requested the data writing. FIG. 12 is a flowchart illustrating the write data reception process applied in the modification of the embodiment. FIGS. 13A and 13B are diagrams respectively showing first data storage states of the data buffer 16 and the flash memory 10 in the write data reception process applied in the modification. FIGS. 14A and 14B are diagrams respectively showing second data storage states of the data buffer 16 and the flash memory 10 in the write data reception process applied in the modification. FIGS. 15A and 15B are diagrams respectively showing third data storage states of the data buffer 16 and the flash memory 10 in the write data reception process applied in the modification. FIGS. 16A and 16B are diagrams respectively showing fourth data storage states of the data buffer 16 and the flash memory 10 in the write data reception process applied in the modification.

First, with reference to FIGS. 13A and 13B, the data storage states of the data buffer 16 and the flash memory 10 prior to reception of a write command from the host 26 will be described. As shown in FIG. 13A, data is already stored in B1 and B2 in the data buffer 16. In the example shown in FIG. 13A, B1 is not only in an unwritten state but also in a state where the writing of the data stored in B1 to P17 in the flash memory 10 has been reserved (reserved state). Similarly, B2 is not only in the unwritten state but also in a state where the writing of the data stored in B2 to P18 in the flash memory 10 has been reserved (reserved state).

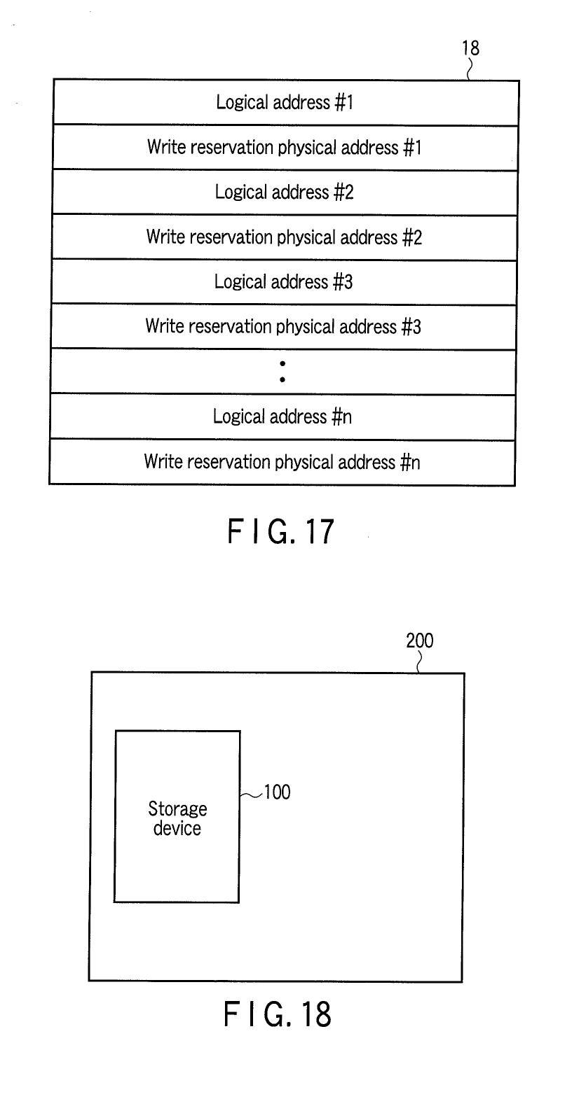

An example of this reservation method will be described with reference to FIG. 17. FIG. 17 shows an example of the data structure of the data buffer management table 18 applied in the modification of the embodiment. In the medication, unlike in the case of the embodiment, the data buffer management table 18 not only holds logical addresses corresponding to the data stored in the respective buffer areas in the data buffer 16 but also the physical address of any of the first blocks in the flash memory 10 for which the writing of the data stored in the corresponding buffer area (that is, the corresponding second block) is reserved.

Now, it is assumed that the MPU 14 has received a write command from the host 26 (block S30). Then, the MPU 14 determines whether or not there is at least one first block in the flash memory for which no write reservation is intended and from which data has been erased (block S32). Here, as a specific example, the write command received by the MPU 14 is assumed to request the writing of six blocks of data.

In the state shown in FIG. 13B, data has been erased from P1, P4, P19, and P20 in the flash memory 10 for which no write reservation is intended. Thus, the MPU 14 detects (determines) that there is at least one first block in the flash memory for which no write reservation is intended and from which data has been erased (Yes in block S32). In this case, the MPU 14 selects, as a write reservation target block, one of the at least one first block in the flash memory for which no write reservation is intended and from which data has been erased. The MPU 14 then specifies the physical address of the selected block. The MPU 14 reserves the data writing to the selected block from which data has been erased, using a buffer area (second block) in the data buffer 16 in which the write data from the host 26 is to be stored (block S36). For the reservation, the MPU 14 enters not only the logical address specified by the write command but also the specified physical address in the buffer management table 18 in association with the buffer area in the data buffer 16 in which the write data from the host 26 is to be stored.

FIGS. 14A and 14B show an example in which writing of data to P19 is reserved using B3. In this case, writing, to P19, of the data to be stored in B3 is reserved.

Then, the MPU 14 detects (determines) whether or not data writing to first blocks has been reserved for all the second blocks in which the write data corresponding to the write command from the host 26 is to be stored (block S38). If data writing to the first blocks from which data has been erased has been reserved for all the second blocks the write data is to be stored (Yes in block S38), the MPU 14 determines this state to be the above-described predetermined state. In this case, the MPU 14 detects that all of the write data from the host 26 can be written to the flash memory 10 without the need for a data erase operation.

However, in the modification of the embodiment, the write command received from the host 26 requests writing of six blocks of data. Thus, the MPU 14 detects that data writing to the first blocks from which data has been erased has not been reserved for all the second blocks the write data is to be stored. In this case (No in block S38), the MPU 14 returns to block S32.

In the state shown in FIGS. 13A and 13B, no write reservation has been made for but data has been erased from the first blocks P1, P4, P19, and P20 in the flash memory 10. Hence, repeated execution of blocks S32, S36, and S38 allows data writing to P19, P20, P1, and P4 to be reserved using B3, B4, B5, and B6 in the data buffer 16 as shown in FIGS. 14A and 14B. That is, the reservation can be such that the data to be stored in B3, B4, B5, and B6 is written to P19, P20, P1, and P4, respectively.

In the state shown in FIGS. 14A and 14B, data writing to the first block from which data has been erased has not been reserved for all the second blocks (B3 to B8) in which the write data is to be stored. In this case (No in block S38), the MPU returns to block S32.

In block S32, the MPU 14 determines whether or not the flash memory 10 contains any first block for which no write reservation has been made but from which data has been erased. In the state shown in FIGS. 14A and 14B, a write reservation has been made for all the first blocks from which data has been erased. Thus, the MPU 14 detects that the flash memory 10 contains no target first block from which data has been erased (No in block S32). In this case, the MPU 14 selects one of the first blocks that hold invalid data, and erases the invalid data from the selected first block (block S34). For example, the MPU 14 selects P7 that holds invalid data, from the flash memory 10 in the state shown in FIG. 14B, and then erases the data from P7. Thus, P7 shifts from the invalid state to the unused state shown in FIG. 15B.

Then, the MPU 14 reserves data writing to P7 using, for example, B7 in the data buffer 16 (block S36). The MPU 14 thus reserves writing, to P7, of the data to be stored in B7. Also for B8 in the data buffer 16, the MPU 14 executes blocks S32, S36, and S38 to reserve, for example, data writing to P8 using B8. Then, writing, to P8, of the data to be stored in B8 can be reserved. As a result, as shown in FIGS. 15A and 15B, data writing to a first block can be reserved for all of B3 to B8.

In this state, the MPU 14 detects that a first block has been reserved for all the second blocks in the data buffer 16 in which the write data is to be stored (Yes in block S38). In this case, the MPU 14 allows the data buffer 16 to receive all of the write data corresponding to the write command received from the host 26 (block S40). Thus, as shown in FIG. 16A, six blocks of write data are received and stored in B3 to B8 in the data buffer 16, respectively.

In the above description, the process in accordance with the flowchart in FIG. 12 is executed by the MPU 14. More specifically, block S30 is executed by the command reception module 38 in the MPU 14 shown in FIG. 11. Block S32 is executed by the block detector 40 in the MPU 14 shown in FIG. 11. Similarly, block S34 is executed by the data erase module 42 in the MPU 14 shown in FIG. 11. Block S36 is executed by the reservation controller 44 in the MPU 14 shown in FIG. 11. Similarly, block S38 is executed by the write detector 46 in the MPU 14 shown in FIG. 11. Block S40 is executed by the data reception controller 48 in the MPU 14 shown in FIG. 11.

Here, it is assumed that in the states shown in FIGS. 16A and 16B, the storage device 100 is powered off. In this case, instead of the power source for the storage device 100, the secondary cell 24 applies (supplies) a voltage (power) to the MPU 14, RAM 22, and the like in the storage device 100. Thus, the data stored in the data buffer 16 is written to the flash memory 10 under the control of the MPU 14.

In the states shown in FIGS. 16A and 16B, a reservation has been made for the data stored in B1 to B8 in the data buffer 18 such that the data is to be written to the first blocks in the flash memory 10 from which data has been erased. Here, the reservation is such that the data stored in B1, B2, B3, B4, B5, B6, B7, and B8 is to be written to P17, P18, P19, P20, P1, P4, P7, and P8. Thus, the data stored in B1, B2, B3, B4, B5, B6, B7, and B8 can be written to P17, P18, P19, P20, P1, P4, P7, and P8 without the need for a data erase operation.

As described above, according to the modification of the embodiment, the MPU 14 reserves a data write, to the first blocks from which data has been erased, of all the second blocks in which the write data transmitted by the host 26 is to be stored, and then allows the data buffer 16 to receive the write data from the host 26. Thus, the data stored in the data buffer 16 can be written to the flash memory 10 without the need for a data erase operation. That is, according to the modification of the embodiment, all the data stored in the data buffer 16 can be written to the flash memory in a short time. Hence, even if the capacity of the secondary cell is reduced, all the data stored in the data buffer 16 can be written to the flash memory 10 while power is being supplied by the secondary cell 24. In other words, the capacity of the secondary cell 24 can be reduced without causing a loss of the data stored in the data buffer 16.

Furthermore, according to the modification of the embodiment, the target to which the data to be stored in the data buffer 16 is to be written is predetermined in terms of second blocks (buffer areas). Thus, compared to the embodiment, the modification enables a reduction in time required to write the data stored in the data buffer 16 to the flash memory 10. Hence, compared to the embodiment, the modification enables the capacity of the secondary cell 24 to be reduced.

The data buffer management table 18 applied in the embodiment holds logical addresses for the respective buffer areas. In contrast, as shown in FIG. 17, the data buffer management table 18 applied in the modification of the embodiment holds, for each buffer area, not only the logical address but also the physical addresses of the first blocks for which a write has been reserved. Thus, compared to the modification of the embodiment, the embodiment enables the capacity of the data buffer management table 18 to be reduced.

In the embodiment and modification, one of the first blocks each of which holds invalid data and from each of which data is to be erased is selected, and data is then erased from the selected first block. However, data may be erased from a plurality of first blocks at a time.

The storage device 100 shown in FIG. 1 can be provided in an electronic device. FIG. 18 shows the configuration of an electronic device 200 comprising the storage device 100. Although not shown in FIG. 18, the storage device 100 is, for example, connected to the host 26 shown in FIG. 1. The electronic device 200 is a device having the function of storing data, for example, a telephone, an audio device, a personal computer, or a video recorder. Storage devices with flash memories are excellent in impact resistance and the like. Thus, portable electronic devices such as a cellular phone, a portable audio device, and a notebook personal computer preferably comprise the storage device 100 with the flash memory 10 applied in the embodiment and modification.

The various modules of the storage device described herein can be implemented as software applications, hardware and/or software modules. While the various modules are illustrated separately, they may share some or all of the same underlying logical or code.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. A storage device comprising:
a flash memory;
a write detector configured to detect a predetermined state where the flash memory comprises an area configured to erase old data and to store new data subject to a write request from a host; and
a data reception controller configured to allow a data buffer to receive the write requested data in accordance with the detection of the predetermined state.

2. The storage device of claim 1, further comprising a data eraser configured to erase invalid data if the predetermined state is not detected.

3. The storage device of claim 1, further comprising:
a first storage area in the flash memory divided into first blocks being in erase units; and
a second storage area in the data buffer divided into second blocks, the second blocks each comprising the same size as the first blocks,
wherein the write detector is configured to detect a state where a total data size of second blocks already occupied by data in the data buffer and second blocks in the data buffer to be occupied by the write requested data is equal to or smaller is than a data size of first blocks in the flash memory configured to store new data, as the predetermined state.

4. The storage device of claim 3, further comprising a data eraser configured to erase invalid data from at least one first block in the flash memory, in order to provide an area configured to erase old data and to store new data, if the total data size exceeds the data size of first blocks configured to store the new data.

5. The storage device of claim 1, further comprising:
a first storage area in the flash memory divided into first blocks being erase units;
a second storage area in the data buffer divided into second blocks, the second blocks each comprising the same size as a size of the first block;
a reservation controller configured to reserve the first blocks in the flash memory configured to store new data, using second blocks in the data buffer comprising the write requested data; and
the write detector is configured to detect a state where the first blocks configured to store the new data has been reserved using the second blocks comprising the write requested data, as the predetermined state.

6. The storage device of claim 5, wherein the reservation controller is configured to reserve a first block configured to store new data, using an unreserved second block if one of the second blocks comprising the write requested data is the unreserved second block.

7. The storage device of claim 6, further comprising a data eraser configured to erase invalid data from a first block in the flash memory for a reservation using the unreserved second block if the flash memory does not comprise a first block configured to store new data.

8. An electronic device comprising:
a storage device comprising:
a flash memory;
a write detector configured to detect a predetermined state where the flash memory comprises an area configured to erase old data and to store new data subject to a write request from a host; and
a data reception controller configured to allow a data buffer to receive the write requested data in accordance with the detection of the predetermined state; and
the host connected to the storage device.

9. A method for controlling reception of data in a storage device comprising a flash memory, the method comprising:
detecting a predetermined state where the flash memory comprises an area configured to store new data subject to a write request from a host; and
allowing a data buffer to receive the write requested data in accordance with the detection of the predetermined state.

10. The method of claim 9, further comprising erasing invalid data if the predetermined state is not detected.

11. The method of claim 9, wherein the storage device comprises:
a first storage area in the flash memory divided into first blocks being in erase units; and
a second storage area in the data buffer divided into second blocks, the second blocks each comprising the same size as first blocks; and
wherein the predetermined state is a state where a total data size of second blocks already occupied by data in the data buffer and second blocks in the data buffer to be occupied by the write requested data is equal to or smaller than a data size of first blocks in the flash memory configured to erase old data and to store new data.

12. The method of claim 11, further comprising erasing invalid data from at least one first block in the flash memory, in order to provide an area configured to store new data, if the total data size exceeds the data size of first blocks configured to store the new data.

13. The method of claim 9, further comprising:
reserving the first blocks configured to erase old data and to store new data in the flash memory in erase units, using second blocks in the data buffer comprising the write requested data, the second blocks each comprising the same size as a size of the first block,
wherein the predetermined state is a state where the first blocks configured to store the new data has been reserved using the second blocks comprising the write requested data.

14. The method of claim 13, further comprising reserving the first block configured to store the new data using an unreserved second block if one of the second blocks comprising the write requested data is the unreserved second block.

15. The method of claim 14, further comprising erasing invalid data from a first block in the flash memory for a reservation using the unreserved second block if the flash memory does not comprise a first block configured to store new data.
